(19) United States
(12) Patent Application Publication
(10) Pub. No.: US 2010/0213706 A1
(43) Pub. Date: Aug. 26, 2010

(54) THREADLESS DRILLPIPE CONNECTOR

(75) Inventor: Jean P. Buytaert, Mineral Wells, TX (US)

Correspondence Address: OSHA LIANG LLP - Frank's International, TWO HOUSTON CENTER, 909 FANNIN STREET, SUITE 3500, Houston, TX, 77010, US

(73) Assignee: FRANK'S INTERNATIONAL, INC., Houston, TX (US)

(21) Appl. No.: 12/710,166

(22) Filed: Feb. 22, 2010

Related U.S. Application Data
(60) Provisional application No. 61/155,607, filed on Feb. 26, 2009.

(51) Int. Cl. F16L 19/00

(52) U.S. Cl. 285/361

(57) ABSTRACT

A threadless tubular connector includes a first component having a first tubular axis defined therethrough and configured to engage a second component having a second tubular axis defined therethrough, and a retaining member configured to maintain an alignment of the first tubular axis with the second tubular axis.

### CROSS-REFERENCE TO RELATED APPLICATIONS

This application claims benefit, under 35 U.S.C. §119, of U.S. Provisional Application Ser. No. 61/155,607, filed on Feb. 26, 2009 and entitled “Threadless Drillpipe Connector” in the name of Jean P. Buytaert. The disclosure of this U.S. Provisional Application is incorporated herein by reference in its entirety

### BACKGROUND

1. Field of the Disclosure

Embodiments disclosed herein relate generally to tubular connectors. In particular, embodiments disclosed herein relate to threadless drillpipe connectors.

2. Background Art

In oilfield exploration and production operations, various oilfield tubulars are used to perform tasks, including, but not limited to, drilling the wellbore. For example, a long assembly of drill pipes, known in the industry as a drill string, may be used to rotate a drill bit at a distal end to create the wellbore.

As such, strings of drill pipe are often connected together, end-to-end by threaded connections, for example, where a female “pin” member of a first tubular is configured to threadably engage a corresponding male “box” member of a second tubular. The process by which threaded connections are screwed together is called “making-up” a threaded joint and the process by which the connections are disassembled is referred to “breaking-out” the threaded joint. As would be understood by one having ordinary skill, individual pieces (or “joints”) of oilfield tubulars come in a variety of diameters, configurations, and lengths.

However, making-up and breaking-out threaded joints, especially several hundred threaded joints that are assembled together to form a tubular string, may consume a great amount of time. In the event of an emergency, such as inclement weather, the faster a tubular string can be disassembled the better. Additionally, a tubular string with threaded connections may be limited to one direction of rotation in the wellbore. For example, if the direction of rotation were reversed, the threaded connections may loosen, possibly resulting in disassembly of the connection downhole or at the surface.

Accordingly, there exists a need for a tubular connector capable of fast and efficient assembly and disassembly. Additionally, a tubular connector that provides greater downhole control would be beneficial in the industry.

### SUMMARY OF THE DISCLOSURE

In one aspect, embodiments disclosed herein relate to a threadless tubular connector including a first component having a first tubular axis defined therethrough and configured to engage a second component having a second tubular axis defined therethrough, and a retaining member configured to maintain an alignment of the first tubular axis with the second tubular axis.

In other aspects, embodiments disclosed herein relate to a threadless tubular connector having a tubular axis defined therethrough, the tubular connector including a first component including a receiving socket, a second component including a key configured to engage the receiving socket of the first component, and a retaining member configured to maintain alignment of the first component and the second component with the tubular axis, wherein the first component is configured to transmit torque to the second component.

In other aspects, embodiments disclosed herein relate to a method of connecting two components, the method including providing a first component having a first tubular axis defined therethrough, providing a second component having a second tubular axis defined therethrough, engaging the first component and the second component and axially aligning the first tubular axis and the second tubular axis, and providing a retaining member to maintain the axial alignment of the first tubular axis and the second tubular axis, and engaging a key of the second component with a receiving socket of the first component, wherein the first component is configured to transmit torque to the second component.

Other aspects and advantages of the invention will be apparent from the following description and the appended claims.

### BRIEF DESCRIPTION OF DRAWINGS

FIG. 1 is an assembly view of a threadless tubular connector in accordance with embodiments of the present disclosure.

FIG. 2A is a component view of a first component in accordance with embodiments of the present disclosure.

FIG. 2B is an end view of the first component of FIG. 2A in accordance with embodiments of the present disclosure.

FIG. 3A is a component view of a second component in accordance with embodiments of the present disclosure.

FIG. 3B is an end view of the second component of FIG. 3A in accordance with embodiments of the present disclosure.

FIG. 4 is an assembly view of a threadless tubular connector with a retaining sleeve in accordance with embodiments of the present disclosure.

FIG. 5A is a section view of a rotationally locking threadless tubular connector prior to being locked in accordance with embodiments of the present disclosure.

FIG. 5B is an end view of a rotationally locking threadless tubular connector prior to being locked in accordance with embodiments of the present disclosure.

FIG. 6A is a section view of a rotationally locking threadless tubular after being locked in accordance with embodiments of the present disclosure.

FIG. 6B is an end view of a rotationally locking threadless tubular after being locked in accordance with embodiments of the present disclosure.

FIGS. 7A and 7B are section views showing an internally gear driven sealing mechanism in an unsealed and sealed position, respectively, in accordance with embodiments of the present disclosure.

FIGS. 8A and 8B are section views showing a spring-biased sealing mechanism in an unsealed and sealed position, respectively, in accordance with embodiments of the present disclosure.

### DETAILED DESCRIPTION

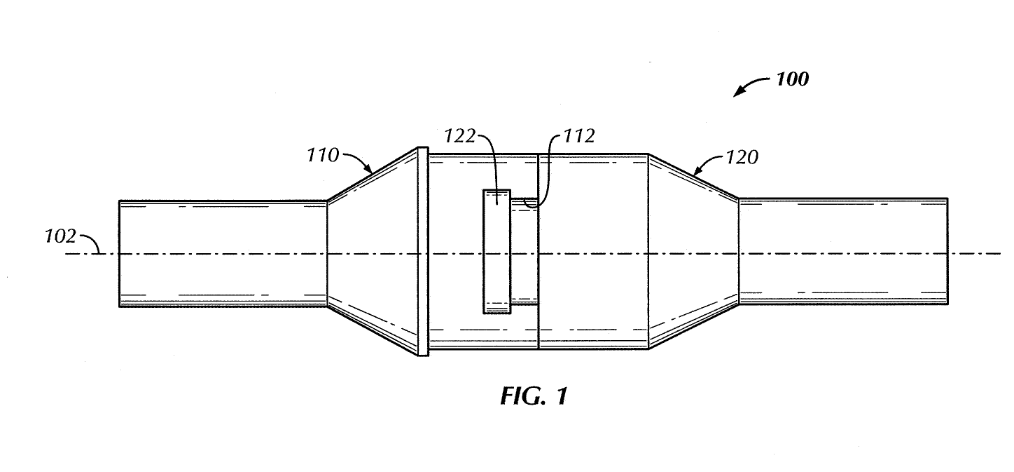

In one aspect, embodiments disclosed herein relate to a threadless drillpipe connector. Referring to FIG. 1, an assembled view of a threadless drillpipe connector 100 in accordance with embodiments of the present disclosure is shown. The threadless connector 100 may include a first component 110 configured to engage a second component 120, both of which may be axially aligned along a central tubular axis 102. In selected embodiments, the first component 110 may comprise a receiving socket 112 formed therein, which may be configured to engage a key 122 of the second component 120.

As shown, the receiving socket 112 of the first component 110 and the key 122 of the second component 120 may be configured to slidably engage in a plane intersecting the central axis 102. For example, in certain embodiments, the plane in which the components slidably engage may be perpendicular to the central axis 102. However, one of ordinary skill in the art will understand that the angle between the central axis 102 and the plane in which the first and second components slidably engage may be varied.

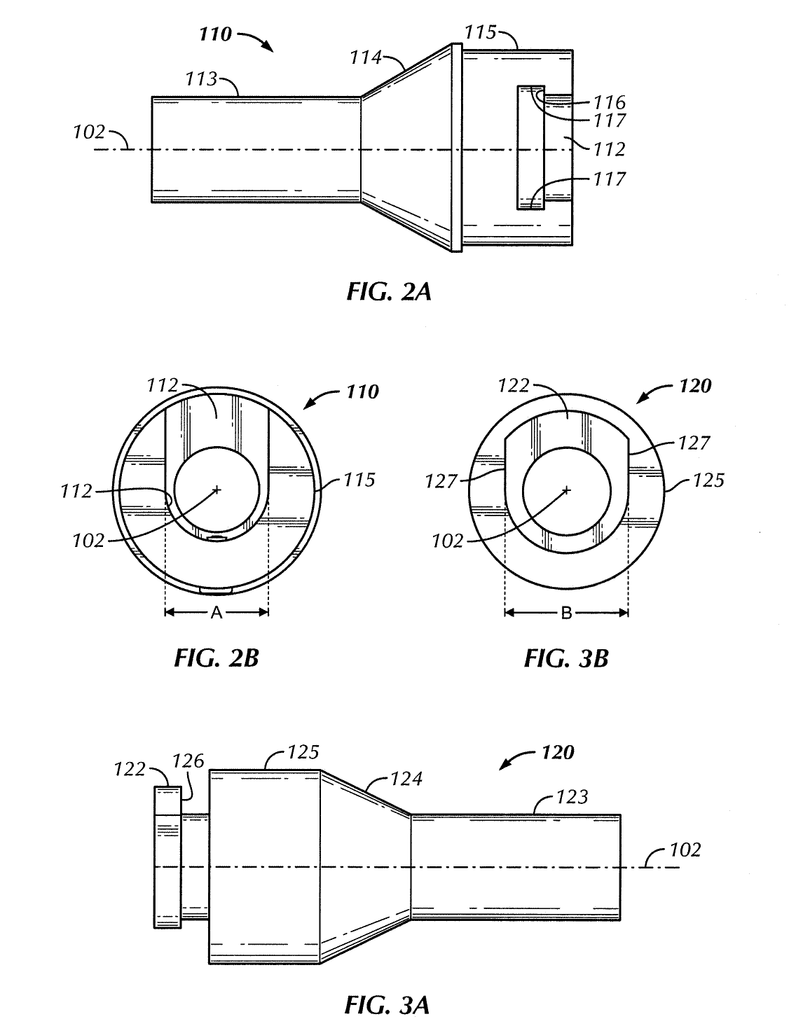

Referring now to FIGS. 2A and 2B, side and end views of the first component 110 are shown in accordance with embodiments of the present disclosure. As shown, the first component 110 may include a length of a tubular section 113, which may be welded (e.g., friction welded) or otherwise non-rotationally attached as known to those skilled in the art. Alternatively, the first component 110 and the length of tubular section 113 may be formed together in a single piece (i.e., unitary). Further, the first component 110 may include a transition section 114 increasing from a diameter of the tubular section 113 to a diameter of a profiled section 115. As shown, the receiving socket 112 may be located in a proximate end of the profiled section 115 of the first component 110. The receiving socket 112 may be formed to engage with a key 112 of the second component 120 (FIGS. 3A and 3B), and may have substantially planar inner walls 117. Additionally, a lip 116 of the receiving socket 112 may be configured to interfere with the key 122 of the second component, as will be discussed below in greater detail.

Now referring to FIGS. 3A and 3B, side and end views of the second component 120 are shown in accordance with embodiments of the present disclosure. Similarly, the second component may include a length of a tubular section 123, welded or otherwise non-rotationally attached. The diameter of the tubular section 123 may be substantially equal to the diameter of tubular section 113 (FIG. 2A). The second component 120 may also include a transition section 124 increasing from the diameter of the tubular section 123 to a diameter of a profiled section 125. The outer diameter of the profiled section 125 of the second component 120 may be substantially equal to the outer diameter of the profiled section 115 (FIG. 2A) of the first component, thereby creating a flush profile when the components 110, 120 are engaged. In alternate embodiments (not shown), a diameter of the tubular section 113 may be substantially equal to a diameter of the profiled section 115 on the first component 110, and a diameter of the tubular section 123 may be substantially equal to a profiled section 125 on the second component 120, such that a constant outer diameter is formed when the first component 110 and the second component 120 are joined.

Referring to FIGS. 1, 2A-2B, and 3A-3B together, when the first component 110 and the second component 120 are engaged, they are restricted from moving in an axial direction (along the central axis 102) relative to each other. As shown in the embodiments in FIGS. 2A, 2B and 3B, the lip 116 of the receiving socket 112 (FIG. 2B) has a width A that is less than a width B of the key 122 (FIG. 3B). From this configuration, when the first component 110 is engaged with the second component 120, the lip 116 of the first component 110 may interfere with the key 122 of the second component 120. Thus, the interference between the key 122 and the lip 116 prevents axial movement between the first component 110 and the second component 120.

Additionally, when the first component 110 and the second component 120 are engaged, they may be restricted from rotating about the central axis 102 relative to each other. As shown in FIG. 3B, the key 122 is formed having substantially planar edges 127, which interfere with substantially planar inner walls 117 (shown in FIG. 2A) of the first component 110. Therefore, the planar edges 127, in contact with the planar inner walls 117, do not allow rotation in either direction about the central axis 102. From this configuration, torque may be transmitted from the first component 110 to the second component 120 about the central axis 102 in either direction, or alternatively, torque may be transmitted from the second component 120 to the first component 110 in either direction about the central axis 102. Alternatively, additional engagement profiles between the key 122 of the second component 120 and inner walls 117 of the first component 110. Alternative engagement profiles to prevent or limit rotation between the first and second components may include an oval-shaped profile, a polygonal-shaped profile, and others known to those skilled in the art.

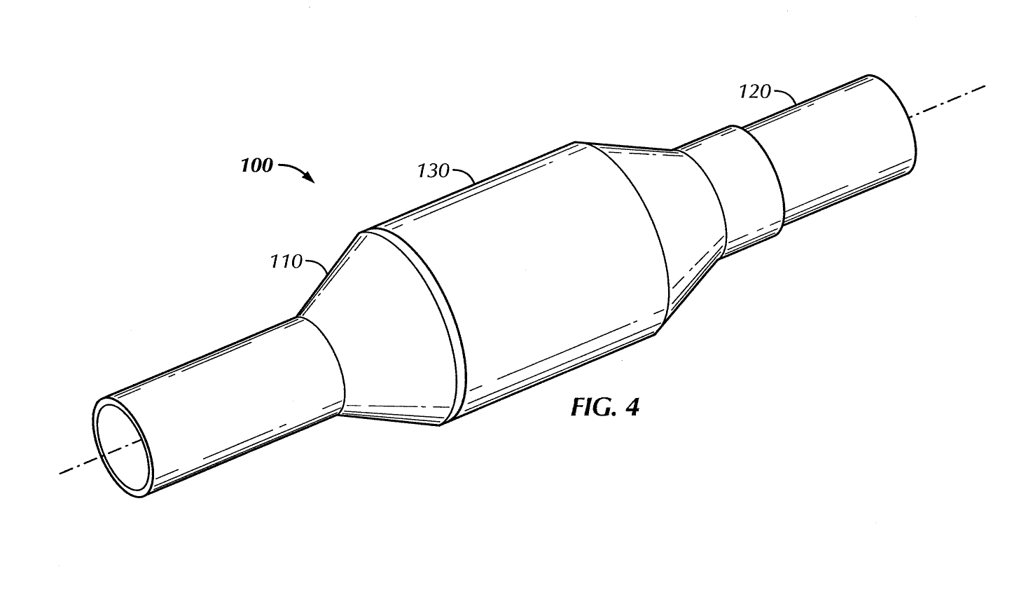

Referring now to FIG. 4, the threadless tubular connector 100 in accordance with embodiments of the present disclosure is shown with a retaining sleeve 130. As shown, the retaining sleeve 130 may be configured to be positioned over at least a portion of the engaged first 110 and second 120 components. The retaining sleeve 130 may be positioned to prevent radial movement between the first 110 and second 120 components, and more specifically, disengagement of the key of the second component 120 from the receiving socket of the first component 110. For example, the retaining sleeve 130 may be configured to maintain an axial alignment of the first component 110 with the second component 120. Retaining sleeve 130 may be held in position (e.g., restricted from sliding off or moving in an axial direction) by a locking mechanism (not shown). For example, in certain embodiments, a spring detent member, integral to either the first or second component, may engage a hole in the retaining sleeve 130, thus locking the retaining sleeve in place. However, it should be understood that other locking mechanisms may be used as would be known to one of ordinary skill in the art.

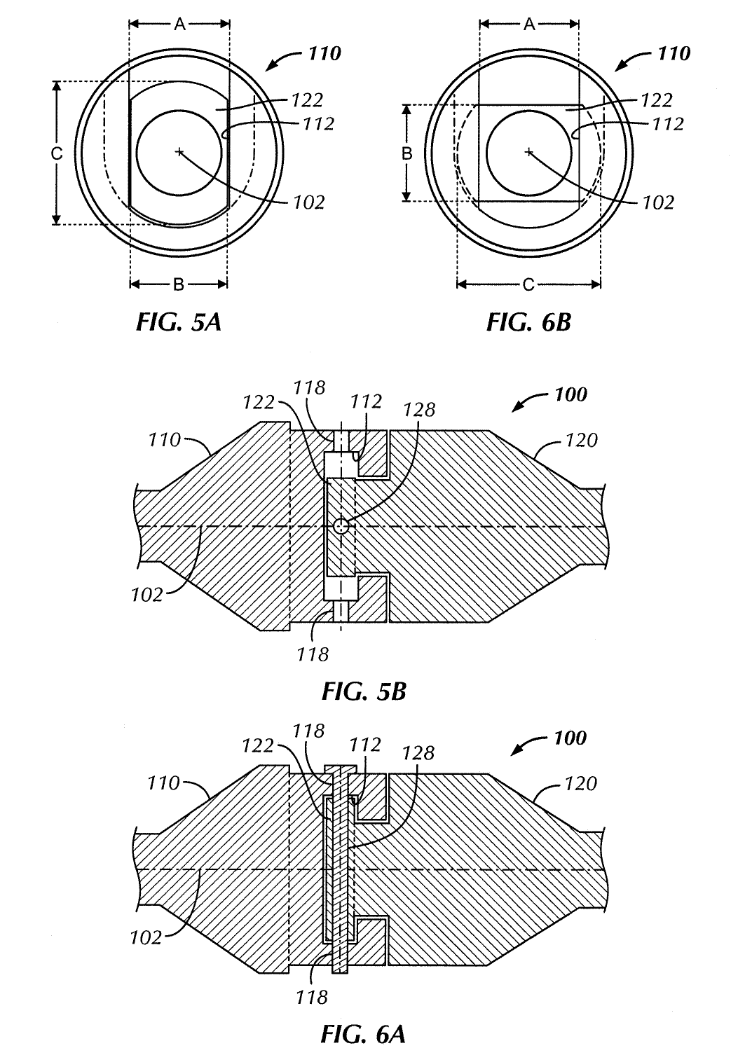

Referring now to FIGS. 5A and 5B, an assembly view of the tubular connector 100 configured such that the first component 110 and the second component 120 are rotationally engaged in accordance with an alternate embodiment of the present disclosure is shown. The key 122 of the second component 120 may be configured to axially engage a receiving socket 112 of the first component 110. As shown in FIG. 5B, the width A of the receiving socket 112 may be configured such that the key 122, having a width B, would be able to fit within and axially engage the receiving socket 112.

Referring now to FIGS. 6A and 6B, an assembly view of the tubular connector 100 after the first component 110 and the second component 120 are rotationally engaged in accordance with embodiments of the present disclosure is shown. After the key 122 is axially engaged with the receiving socket 112, the second component 120 (along with the key 122) may be rotated in a direction R by a selected amount (e.g., 90 degrees), which may lock the components together and prevent the components from moving relative to each other in the axial direction (along central axis 102). As shown, the key 122 may be configured as an elongated shape, having one side with a width C that is greater than width A of the receiving socket 112. Therefore, initially, the key 122 may be positioned such that the width B is aligned with width A of the receiving socket (FIGS. 5A and 5B). After rotating the second component 120, the key 122 is positioned such that the width C is aligned with width A of the receiving socket (FIGS. 6A and 6B). Therefore, the key 122 may be prevented from moving axially with respect to the receiving socket 112.

First component 110 may have holes 118 formed therein, with which a hole 128 in the second component 120 may be aligned when the tubular connector 100 is in the engaged position (FIGS. 6A and 6B). A retaining member, such as a pin, may be inserted through the aligned holes 118 of the first component 110 and hole 128 of the second component to prevent the first component 110 and the second component 120 from rotating relative to each other.

In selected embodiments, a fluid seal may be incorporated into the threadless tubular connector 100 to prevent leaks between the engaged first component 110 and second component 120. For example, a sealing mechanism may be disposed in an inner bore of the tubular connector 100 to provide a sealable engagement between the first component 110 and the second component 120.

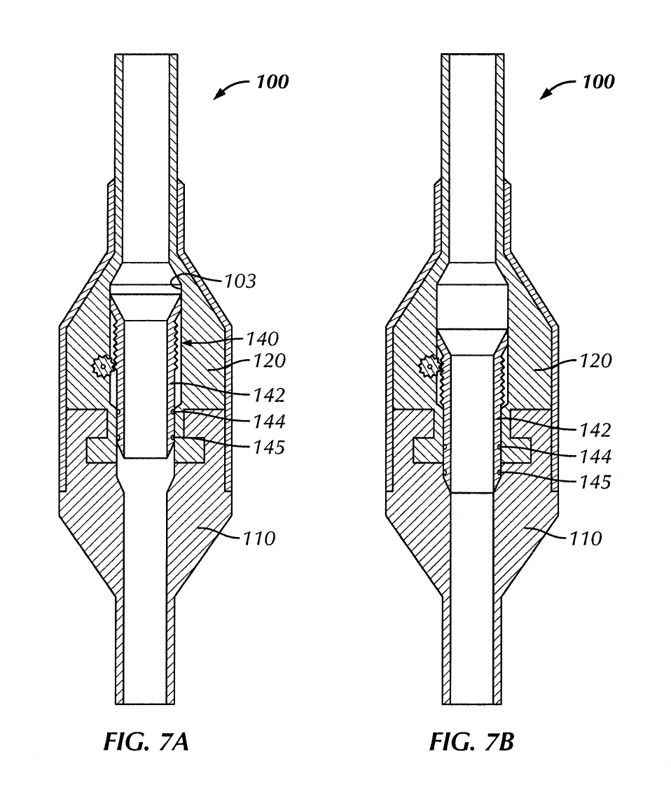

Referring now to FIGS. 7A and 7B, an internally gear driven sealing mechanism 140 in accordance with embodiments of the present disclosure is shown. The sealing mechanism may include a stinger assembly 142, which may move axially within the inner bore 103 of the tubular connector 100. Elastomeric seal (e.g., 144 and 145), for example, an O-ring, may be disposed on the stinger assembly 142. The gear driven sealing mechanism 140 may include a rack-and-pinion configuration, such that as the pinion is rotated, the rack is moved axially in the inner bore 103 of the connector 100. The pinion may be rotated manually using a tool, or as otherwise known to one of ordinary skill in the art. As shown in FIG. 5B, the stinger assembly 142 may be in a sealable engagement with both the first component 110 (seal 145) and the second component 120 (seal 144), if so configured.

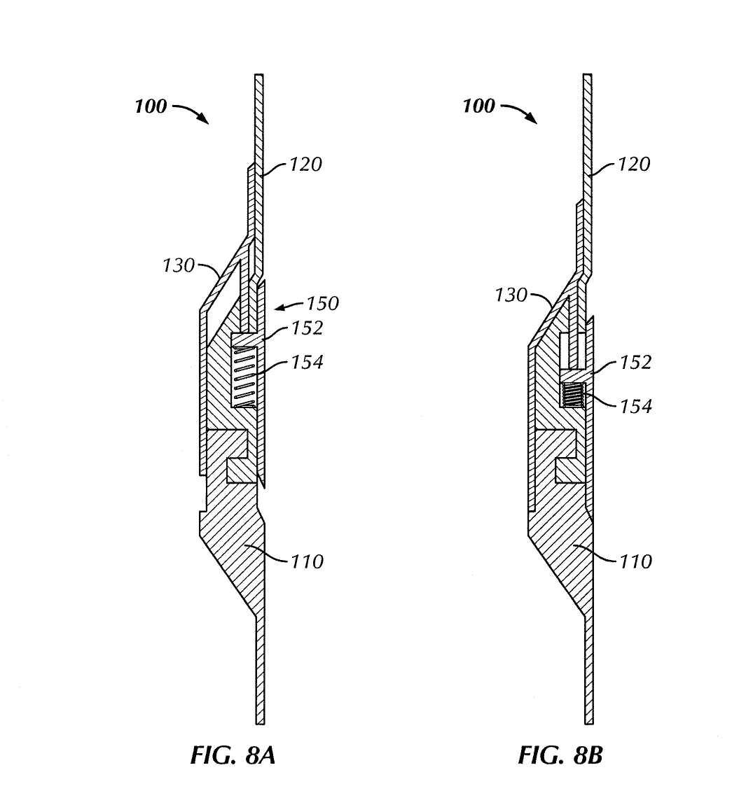

Now referring to FIGS. 8A and 8B, a spring-biased sealing mechanism 150 in accordance with an alternate embodiment of the present disclosure is shown. A slidable and spring-biased sealing mechanism 150 may include a stinger assembly 152, on which elastomeric seals (not shown) may be disposed, e.g.,similar to the configuration shown in FIGS. 5A and 5B. Additionally, the sealing mechanism 150 in FIGS. 8A-8B includes a spring 154, which may be configured to bias the stinger assembly 152 out of sealable engagement with the first component 110. As shown in FIG. 8B, the retaining sleeve 130, e.g., a protrusion thereof, may be configured to contact the stinger assembly 152, and force the stinger assembly 152 into a sealable engagement with the first component 110 and the second component 120.

Advantageously, embodiments of the present disclosure may provide a tubular connector that may be quickly and efficiently assembled and disassembled. Quick assembly and disassembly of the tubular connector may allow a greater length of tubular string to be assembled in a shorter time, which is advantageous both in productivity and cost savings. Additionally, embodiments of the present disclosure may provide a tubular connector which allows greater downhole control of the tubular string in that the tubular connector may be rotated in either direction without loosening or disengaging. As described previously, threaded connections may oftentimes be rotated in only one direction; otherwise the connection may be loosened. However, the threadless connector disclosed herein may be rotated in either direction, thus allowing for greater downhole control over the tubular string (e.g., drillstring).

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. A threadless tubular connector comprising:
a first component having a first tubular axis defined therethrough and configured to engage a second component having a second tubular axis defined therethrough; and
a retaining member configured to maintain an alignment of the first tubular axis with the second tubular axis.

2. The tubular connector of claim 1, wherein the first component and the second component are configured to slidably engage in a plane intersecting with each of the first and the second tubular axes.

3. The tubular connector of claim 1, wherein the first component and the second component are configured to rotationally engage in a plane intersecting with each of the first and the second tubular axes.

4. The tubular connector of claim 1, wherein the second component comprises a key configured to engage a receiving socket of the first component.

5. The tubular connector of claim 1, wherein the retaining member comprises a retaining sleeve configured to be disposed over at least a portion of the first component and the second component.

6. The tubular connector of claim 1, wherein the retaining member comprises a pin configured to prevent rotational movement of the first component and the second component relative to each other.

7. The tubular connector of claim 1, further comprising a sealing mechanism configured to provide a seal between the first component and the second component.

8. The tubular connector of claim 7, wherein the sealing mechanism comprises:
a stinger assembly having a seal disposed thereon;
wherein the stinger assembly is configured to move axially in an inner bore of the tubular connector.

9. The tubular connector of claim 8, wherein an internal gear driven mechanism moves the stinger assembly axially within the inner bore of the tubular connector.

10. The tubular connector of claim 8, further comprising a spring-biased stinger assembly.

11. The tubular connector of claim 7, further comprising an elastomeric seal.

12. A threadless tubular connector having a tubular axis defined therethrough, the tubular connector comprising:
a first component comprising a receiving socket;
a second component comprising a key configured to engage the receiving socket of the first component; and
a retaining member configured to maintain alignment of the first component and the second component with the tubular axis;
wherein the first component is configured to transmit torque to the second component.

13. The tubular connector of claim 12, wherein the receiving socket is configured to slidably engage the key.

14. The tubular connector of claim 12, wherein the receiving socket is configured to rotationally engage the key

15. The tubular connector of claim 12, wherein the retaining member comprises a retaining sleeve configured to be disposed over at least a portion of the first component and the second component.

16. The tubular connector of claim 12, wherein the retaining member comprises a pin configured to prevent rotational movement of the first component and the second component relative to each other.

17. The tubular connector of claim 15, further comprising a locking mechanism to secure the retaining sleeve over at least the portion of the first component and the second component.

18. The tubular connector of claim 12, further comprising a sealing mechanism configured to provide a sealable engagement between the first component and the second component.

19. The tubular connector of claim 18, wherein the sealing mechanism comprises:
a stinger assembly having a seal disposed thereon;
wherein the stinger assembly is configured to move axially in an inner bore of the tubular connector.

20. The tubular connector of claim 19, wherein the stinger assembly comprises an elastomeric seal.

21. The tubular connector of claim 19, wherein an internal gear driven mechanism moves the stinger assembly axially within the inner bore of the tubular connector.

22. The tubular connector of claim 18, further comprising a spring-biased stinger assembly.

23. The tubular connector of claim 12, wherein the retaining member comprises a pin configured to prevent rotational movement of the first component and the second component relative to each other.

24. A method of connecting two components, the method comprising:
providing a first component having a first tubular axis defined therethrough;
providing a second component having a second tubular axis defined therethrough;
engaging the first component and the second component and axially aligning the first tubular axis and the second tubular axis; and
providing a retaining member to maintain the axial alignment of the first tubular axis and the second tubular axis;
engaging a key of the second component with a receiving socket of the first component;
wherein the first component is configured to transmit torque to the second component.

25. The method of claim 24, further comprising slidably engaging the first component and the second component in a plane intersecting with each of the first and the second tubular axes.

26. The method of claim 24, further comprising providing a seal between the first component and the second component.
